(19) United States
(12) Patent Application Publication
(10) Pub. No.: US 2007/0299176 A1
(43) Pub. Date: Dec. 27, 2007

(54) Photodefinable low dielectric constant material and method for making and using same

(76) Inventors: Thomas John Markley, Blandon, PA (US); Scott Jeffrey Weigel, Allentown, PA (US); Christine Peck Kretz, Macungie, PA (US); Thomas Albert Braymer, Allentown, PA (US); James Edward Mac Dougall, New Tripoli, PA (US); Cecilia Anna Paulette Petit, Quakertown, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 11/341,334

(22) Filed: Jan. 27, 2006

Related U.S. Application Data
(60) Provisional application No. 60/647,884, filed on Jan. 28, 2005.

(51) Int. Cl. B05D 3/02; B05D 3/06; B60C 1/00; C08L 83/04

(52) U.S. Cl. 524/261; 427/387; 524/588

(57) ABSTRACT

A photodefinable, organosilicate material having a dielectric constant (κ) of 3.5 or below and a method for making and using same, for example, in an electronic device, is described herein. In one aspect, there is provided a composition for preparing a photodefinable material comprising: a silica source capable of being sol-gel processed and having a molar ratio of carbon to silicon within the silica source contained therein of at least 0.5 or greater; a photoactive compound; optionally a solvent; and water provided the composition contains 0.1% by weight or less of an added acid where the acid has a molecular weight of 500 or less.

### CROSS-REFERENCE TO RELATED APPLICATIONS

This application claims the benefit of U.S. Provisional Application No. 60/647,884 filed Jan. 28, 2005. The disclosure of the Provisional Application is hereby incorporated by reference.

### BACKGROUND OF THE INVENTION

There is a continuing desire in the microelectronics industry to increase the circuit density in multilevel integrated circuit devices such as memory and logic chips in order to improve the operating speed and reduce power consumption. In order to continue to reduce the size of devices on integrated circuits, it has become necessary to use insulators having a low dielectric constant (κ) to reduce the resistance-capacitance (“RC”) time delay of the interconnect metallization and to prevent capacitive crosstalk between the different levels of metallization. Such low dielectric constant materials are desirable for premetal dielectric layers and interlevel dielectric layers.

Current fabrication routes of integrated circuits include numerous processing steps to place metal features in a specific location within a low dielectric constant film. These steps include the deposition of a low dielectric film, deposition of a photoresist, creating a pattern into the photoresist, etching through the pattern into the low dielectric constant film, removal of the photoresist, and cleaning residues from the patterned film. This processing is repeated several times during the formation of an integrated circuit. These patterning steps are time consuming, expensive, and could potentially introduce defects into the device.

In recent years, there is a growing trend to prepare dielectric materials that are also photodefinable, i.e., inherently capable of forming a pattern using a lithographic process without the need for an added photoresist. In this regard, the lithographic process generally involves depositing a photodefinable dielectric layer onto a substrate, exposing the layer to an ionizing radiation source to provide a latent image, and developing the layer to form the pattern. This pattern then acts as a mask for subsequent substrate patterning processes such as, for example, etching, doping, ashing, and/or coating with metals, other semiconductor materials, or insulating materials. The patterned image may be positive or negative.

### BRIEF SUMMARY OF THE INVENTION

The instant invention relates to a photodefinable, organosilicate material having a dielectric constant (κ) of about 3.5 or below, and a method for making and using same as described herein. In one aspect, there is provided a composition for preparing a photodefinable material comprising: at least one silica source capable of being sol-gel processed and having a molar ratio of carbon to silicon within the silica source of at least about 0.5 or greater; optionally at least one solvent; at least one photoactive compound; and water. Normally, the composition is substantially free of added acid or contains about 0.1% by weight or less of an added acid where the acid has a molecular weight of about 500 or less.

In another aspect, there is provided a silica source capable of being sol-gel processed and comprising a compound selected from the group consisting of compounds represented by at least one of the following formulas: RₐSi(OR¹)₄₋ₐ, wherein R independently represents a hydrogen atom, a fluorine atom, or a monovalent organic group; R¹ represents a monovalent organic group; and a is an integer 1 or 2; Si(OR²)₄, where R² represents a monovalent organic group; R³_{b}(R⁴O)_{3-b}Si—R⁷—Si(OR⁵)_{3-c}R⁶_{c}, wherein R⁴ and R⁵ may be the same or different and each represents a monovalent organic group; R³ and R⁶ may be the same or different; b and c may be the same or different and each is a number ranging from 0 to 3; R⁷ represents an oxygen atom, a phenylene group, a biphenyl, a napthylene group, or a group represented by —(CH₂)ₙ—, wherein n is an integer ranging from 1 to 6; and mixtures thereof; at least one photoactive compound; optionally at least one solvent; and water. Normally, the composition contains about 0.1% by weight or less of an added acid where the acid has a molecular weight of about 500 or less and has a molar ratio of carbon to silicon within the silica source contained therein of at least about 0.5 or greater.

In another aspect, there is provided a process for preparing a patterned film comprising a dielectric constant of about 3.5 or less on at least a portion of a substrate comprising: providing a composition comprising: at least one silica source capable of being sol-gel processed and having a molar ratio of carbon to silicon within the silica source of at least about 0.5 or greater; optionally at least one solvent; at least one photoactive compound; and water. Normally, the composition contains about 0.1% by weight or less of an added acid where the acid has a molecular weight of about 500 or less; depositing the composition onto a substrate to form a coated substrate; exposing the coated substrate to an ionizing radiation source (e.g., such as ultraviolet (UV) light), to form a latent image on at least a portion of the coated substrate; applying at least one developer solution to the coated substrate to form a patterned coated substrate; and curing the patterned coated substrate to provide the patterned film.

In a further aspect, there is provided a film comprising: at least one pattern, a dielectric constant of about 3.5 or less, and the elements comprising at least one of silicon, carbon, hydrogen, and oxygen; wherein a molar ratio of carbon to silicon is about 0.5 or greater where the film is formed from a hydrolysable silica source.

In another aspect, there is provided a composition for forming a photodefinable material having a dielectric constant of about 3.5 or less on at least a portion of a substrate comprising: providing a composition comprising: at least one silica source capable of being sol-gel processed and has a molar ratio of carbon to silicon within the silica source contained therein of at least about 0.5 or greater wherein the silica source comprises at least one compound selected from the group consisting of compounds represented by the following formulas:
a. RₐSi(OR¹)₄₋ₐ, wherein R independently represents a hydrogen atom, a fluorine atom, or a monovalent organic group; R¹ represents a monovalent organic group; and a is an integer of 1 or 2;
b. Si(OR²)₄, where R² represents a monovalent organic group; and
c. R³_{b}(R⁴O)_{3-b}Si—R⁷—Si(OR⁵)_{3-c}R⁶_{c}, wherein R⁴ and R⁵ may be the same or different and each represents a monovalent organic group; R³ and R⁶ may be the same or different; b and c may be the same or different and each is a number of 0 to 3; R⁷ represents an oxygen atom, a phenylene group, a biphenyl, a napthalene group, or a group represented by —(CH₂)ₙ—, wherein n is an integer of 1 to 6; and mixtures thereof; at least one photoactive compound; and water. Normally, the composition contains about 0.1% by weight or less of an added acid where the acid has a molecular weight of about 500 or less.

### BRIEF DESCRIPTION OF FIGURES

FIG. 1 illustrates a flow chart of one aspect of the inventive method.

FIG. 2 shows a cross-sectional view of a transistor covered with the photodefinable dielectric material.

FIG. 3 shows a top-down view of a portion of a transistor array that can be covered with the inventive photodefinable dielectric material.

FIG. 4 is a scanning electron micrograph (SEM) of the photodefinable dielectric material of Example 8.

### DETAILED DESCRIPTION OF THE INVENTION

The instant invention relates to a photodefinable organosilicate material or film having a dielectric constant (κ) of about 3.5 or below and a method for making and using same are described herein. The term “photodefinable” as used herein relates to a material or film that is inherently capable of forming a pattern using a lithographic process without the need for an added photoresist. Although the material described herein is particularly suitable for providing films and the products are largely described herein as films, it is not limited thereto. The material described herein can be provided in any form capable of being deposited by spin-on deposition, among other techniques, including, without limitation, coatings, multi-laminar assemblies, and other types of objects that are not necessarily planar or relatively thin, and a multitude of objects not necessarily used in integrated circuits. The material or film described herein may be used, for example, in electronic devices including, without limitation, flat panel displays, flexible displays, photovoltaics, solar cells, basic logic devices, integrated circuits, memory manufacturing, RFID tags, sensors, smart objects, X-ray imaging or other imaging devices, among other devices.

The composition that forms the inventive material or film comprises at least one photoactive compound such as photoacid generator (PAG), photobase generator, and/or at least one photosensitizer that may act as both the porogen and active ingredient within the material or film to provide a pattern after lithographic processing. In this connection, the dual use of the photoactive compound provides at least one of the following advantages: lowers the dielectric constant; reduces swelling in the presence of solvents; prevents bridging of substrate features; and/or may be image developable in aqueous developer solutions, non-aqueous developer solutions, water, and combinations thereof. In certain embodiments, the inventive composition may provide a film that planarizes substrates and/or various features on those substrates.

In one aspect, the photodefinable material described herein requires no additional post-treatment steps to remove the hydroxyl functionality thereby forming a hydrophobic film. In contrast to the materials and films described herein, conventional silica-based films that contain no organic species attached to the Si atom absorb moisture from the air because the surface is terminated only in hydroxyls. Termination of the silica network with hydroxyls and water in the pore systems may result in films that exhibit a relatively higher dielectric constant. The inventive material and films can be substantially free of hydroxyl functionality.

The materials disclosed herein are typically prepared from a composition that comprises at least one silica source, at least one photoactive compound, optionally at least one solvent, and water wherein the total molar ratio of carbon to silicon atoms of all the silica sources contained within the composition is about 0.5 or greater. In certain embodiments, the composition may optionally include at least one porogen that is incapable of forming a micelle in the composition and/or optionally include at least one base to adjust the pH of the composition to a range of from about 0 to about 7. The composition may be prepared prior to forming the photodefinable film or, alternatively, during at least a portion of the film forming process. In certain embodiments, the composition is also substantially free of an added acid. In this connection, the composition described herein does not necessarily need an added acid to catalyze the hydrolysis of chemical reagents contained therein. The composition, however, may generate an acid in situ such as, for example, in embodiments containing at least one photoactive compound comprising at least one photoacid generator that generates an acid upon exposure to an ionizing radiation source. In embodiments where an acid is added, the composition contains about 0.1% by weight or less of an added acid where the acid has a molecular weight of about 500 or less. The term “% by weight” as used herein refers to the percentage of the reagent relative to the total weight of the composition.

In certain embodiments, the composition and/or process for preparing same uses chemicals within the composition and/or during processing that meet the requirements of the electronics industry because such contains little to no contaminants, such as, for example, metals, decomposition products of photoactive compounds, and/or other compounds that may adversely affect the electrical properties of the film. In these embodiments, the compositions described herein typically contain contaminants in amounts less than about 100 parts per million (ppm), or less than about 10 ppm, or less than about 1 ppm. In one embodiment, contaminants may be reduced by avoiding the addition of certain reagents, such as halogen-containing mineral acids or polymers synthesized using halide counter-ions or alkali metal counter-ions, into the composition because these contaminants may contribute undesirable ions to the materials described herein. In another embodiment, contaminants may be reduced by using solvents in the composition and/or during processing that contain contaminants such metals or halides in amounts less than about 10 ppm, or less than about 1 ppm, or less than about 200 parts per billion (“ppb”). In yet another embodiment, contaminants such as metals may be reduced by adding to the composition and/or using during processing chemicals containing contaminating metals in amounts less than about 10 ppm, or less than about 1 ppm, or less than about 200 ppb. In these embodiments, if the chemical contains about 10 ppm or greater of contaminating metals, the chemical may be purified prior to addition to the composition. US Patent Application Publication No. 2004-0048960, which is incorporated herein by reference and assigned to the assignee of the present application, provides examples of suitable chemicals and methods for purifying same that can be used in the film-forming composition.

As previously described, the composition can comprise at least one silica source. The silica sources are capable of being sol-gel processed such as, for example, by hydrolytic polycondensation or similar means. Monomeric or precondensed, hydrolyzable and condensable compounds having an inorganic central atom such as silicon are hydrolyzed and precondensed by adding water, and optionally a catalyst, until a sol forms and then condensation to a gel is conducted usually by adding a pH-active catalyst or other means. The gel can then be converted into a continuous network by treatment with one or more energy sources such as thermal, radiation, and/or electron beam. The composition may comprise from about 10% to about 95% by weight, or from about 10% to about 75% by weight, or from about 10% to about 65% by weight of at least one silica source. A “silica source”, as used herein, comprises a compound comprising at least one of silicon (Si), oxygen (O), carbon (C), and optionally additional substituents such as, at least one of H, B, P, or halide atoms, organic groups such as alkyl groups, or aryl groups. The total molar ratio of carbon to silicon atoms within the silica source contained therein is typically at least about 0.5 or greater. In determining total molar ratio of the silica source, the carbon described is that from the monovalent organic group or groups that is covalently attached to a silicon atom rather than a carbon atom present incidentally in one or more ligands such as an ethoxy ligand and/or resulting from transesterification reactions. For example, in a composition having an approximately 50/50 mixture by weight of the silica sources tetraethoxysilane (TEOS) and methyltriethoxysilane (MTES), the total molar ratio of carbon to silicon atoms of the silica sources contained therein is about 0.50. By comparison, in a composition where 100% of the silica source is MTES, the total molar ratio of carbon to silicon atoms is about 1.0.

The following are non-limiting examples of silica sources suitable for use in the composition described herein. In the chemical formulas which follow and in all chemical formulas throughout this document, the term “independently” should be understood to denote that the subject R group is not only independently selected relative to other R groups bearing different superscripts, but is also independently selected relative to any additional species of the same R group. For example, in the formula RₐSi(OR¹)₄₋ₐ, when “a” is 2, the two R groups need not be identical to each other or to R¹. In addition, in the following formulas, the term “monovalent organic group” relates to an organic group bonded to an element of interest, such as Si or O, through a single C bond, i.e., Si—C or O—C. Examples of monovalent organic groups comprise an alkyl group, an aryl group, an unsaturated alkyl group, and/or an unsaturated alkyl group substituted with alkoxy, ester, acid, carbonyl, or alkyl carbonyl functionality. The alkyl group may be a linear, branched, or cyclic alkyl group having from 1 to 6 carbon atoms such as, for example, a methyl, ethyl, propyl, butyl, pentyl, or hexyl group. Examples of aryl groups suitable as the monovalent organic group can comprise phenyl, methylphenyl, ethylphenyl and fluorophenyl. In certain embodiments, one or more hydrogens within the alkyl group may be substituted with an additional atom such as a halide atom (i.e., fluorine), or an oxygen atom to give a carbonyl or ether functionality.

In certain embodiments, the silica source may be represented by the following formula: RₐSi(OR¹)₄₋ₐ, wherein R independently represents a hydrogen atom, a fluorine atom, or a monovalent organic group; R¹ independently represents a monovalent organic group; and a is an integer ranging from 1 to 2. Specific examples of the compounds represented by RₐSi(OR¹)₄₋ₐ can comprise at least one member selected from the group of methyltrimethoxysilane, methyltriethoxysilane, methyltri-n-propoxysilane, methyltri-iso-propoxysilane, methyltri-n-butoxysilane, methyltri-sec-butoxysilane, methyltri-tert-butoxysilane, methyltriphenoxysilane, ethyltrimethoxysilane, ethyltriethoxysilane, ethyltri-n-propoxysilane, ethyltri-iso-propoxysilane, ethyltri-n-butoxysilane, ethyltri-sec-butoxysilane, ethyltri-tert-butoxysilane, ethyltriphenoxysilane, n-propyltrimethoxysilane, n-propyltriethoxysilane, n-propyltri-n-propoxysilane, n-propyltri-iso-propoxysilane, n-propyltin-n-butoxysilane, n-propyltri-sec-butoxysilane, n-propyltri-tert-butoxysilane, n-propyltriphenoxysilane, isopropyltrimethoxysilane, isopropyltriethoxysilane, isopropyltri-n-propoxysilane, isopropyltriisopropoxysilane, isopropyltri-n-butoxysilane, isopropyltri-sec-butoxysilane, isopropyltri-tert-butoxysilane, isopropyltriphenoxysilane, n-butyltrimethoxysilane, n-butyltriethoxysilane, n-butyltri-n-propoxysilane, n-butyltriisopropoxysilane, n-butyltri-n-butoxysilane, n-butyltri-sec-butoxysilane, n-butyltri-tert-butoxysilane, n-butyltriphenoxysilane; sec-butyltrimethoxysilane, sec-butyltriethoxysilane, sec-butyltri-n-propoxysilane, sec-butyltriisopropoxysilane, sec-butyltri-n-butoxysilane, sec-butyltri-sec-butoxysilane, sec-butyltri-tert-butoxysilane, sec-butyltriphenoxysilane, tert-butyltrimethoxysilane, tert-butyltriethoxysilane, tert-butyltri-n-propoxysilane, tert-butyltriisopropoxysilane, tert-butyltri-n-butoxysilane, tert-butyltri-sec-butoxysilane, tert-butyltri-tert-butoxysilane, tert-butyltriphenoxysilane, isobutyltrimethoxysilane, isobutyltriethoxysilane, isobutyltri-n-propoxysilane, isobutyltriisopropoxysilane, isobutyltri-n-butoxysilane, isobutyltri-sec-butoxysilane, isobutyltri-tert-butoxysilane, isobutyltriphenoxysilane, n-pentyltrimethoxysilane, n-pentyltriethoxysilane, n-pentyltri-n-propoxysilane, n-pentyltriisopropoxysilane, n-pentyltri-n-butoxysilane, n-pentyltri-sec-butoxysilane, n-pentyltri-tert-butoxysilane, n-pentyltriphenoxysilane; sec-pentyltrimethoxysilane, sec-pentyltriethoxysilane, sec-pentyltri-n-propoxysilane, sec-pentyltriisopropoxysilane, sec-pentyltri-n-butoxysilane, sec-pentyltri-sec-butoxysilane, sec-pentyltri-tert-butoxysilane, sec-pentyltriphenoxysilane, tert-pentyltrimethoxysilane, tert-pentyltriethoxysilane, tert-pentyltri-n-propoxysilane, tert-pentyltriisopropoxysilane, tert-pentyltri-n-butoxysilane, tert-pentyltri-sec-butoxysilane, tert-pentyltri-tert-butoxysilane, tert-pentyltriphenoxysilane, isopentyltrimethoxysilane, isopentyltriethoxysilane, isopentyltri-n-propoxysilane, isopentyltriisopropoxysilane, isopentyltri-n-butoxysilane, isopentyltri-sec-butoxysilane, isopentyltri-tert-butoxysilane, isopentyltriphenoxysilane, neo-pentyltrimethoxysilane, neo-pentyltriethoxysilane, neo-pentyltri-n-propoxysilane, neo-pentyltriisopropoxysilane, neo-pentyltri-n-butoxysilane, neo-pentyltri-sec-butoxysilane, neo-pentyltri-neo-butoxysilane, neo-pentyltriphenoxysilane phenyltrimethoxysilane, phenyltriethoxysilane, phenyltri-n-propoxysilane, phenyltriisopropoxysilane, phenyltri-n-butoxysilane, phenyltri-sec-butoxysilane, phenyltri-tert-butoxysilane, phenyltriphenoxysilane, δ-trifluoropropyltrimethoxysilane, δ-trifluoropropyltriethoxysilane, dimethyldimethoxysilane, dimethyldiethoxysilane, dimethyldi-n-propoxysilane, dimethyldiisopropoxysilane, dimethyldi-n-butoxysilane, dimethyldi-sec-butoxysilane, dimethyldi-tert-butoxysilane, dimethyldiphenoxysilane, diethyldimethoxysilane, diethyldiethoxysilane, diethyldi-n-propoxysilane, diethyldiisopropoxysilane, diethyldi-n-butoxysi lane, diethyldi-sec-butoxysilane, diethyldi-tert-butoxysilane, diethyldiphenoxysilane, di-n-propyldimethoxysilane, di-n-propyldimethoxysilane, di-n-propyldi-n-propoxysilane, di-n-propyldiisopropoxysilane, di-n-propyldi-n-butoxysilane, di-n-propyldi-sec-butoxysilane, di-n-propyldi-tert-butoxysilane, di-n-propyldiphenoxysilane, diisopropyldimethoxysilane, diisopropyldiethoxysilane, diisopropyldi-n-propoxysilane, diisopropyldiisopropoxysilane, diisopropyldi-n-butoxysilane, diisopropyldi-sec-butoxysilane, diisopropyldi-tert-butoxysilane, diisopropyldiphenoxysilane, di-n-butyldimethoxysilane, di-n-butyldiethoxysilane, di-n-butyldi-n-propoxysilane, di-n-butyldiisopropoxysilane, di-n-butyldi-n-butoxysilane, di-n-butyldi-sec-butoxysilane, di-n-butyldi-tert-butoxysilane, di-n-butydiphenoxysilane, di-sec-butyldimethoxysilane, di-sec-butyldiethoxysilane, di-sec-butyldi-n-propoxysilane, di-sec-butyldiisopropoxysilane, di-sec-butyldi-n-butoxysilane, di-sec-butyldi-sec-butoxysilane, di-sec-butyldi-tert-butoxysilane, di-sec-butyldiphenoxysilane, di-tert-butyldimethoxysilane, di-tert-butyldiethoxysilane, di-tert-butyldi-n-propoxysilane, di-tert-butyldiisopropoxysilane, di-tert-butyldi-n-butoxysilane, di-tert-butyldi-sec-butoxysilane, di-tert-butyldi-tert-butoxysilane, di-tert-butyldiphenoxysilane, diphenyldimethoxysilane, diphenyldiethoxysilane, diphenyldi-n-propoxysilane, diphenyldiisopropoxysilane, diphenyldi-n-butoxysilane, diphenyldi-sec-butoxysilane, diphenyldi-tert-butoxysilane, diphenyldiphenoxysilane, methylneopentyldimethoxysilane, methylneopentyldiethoxysilane, methyldimethoxysilane, ethyldimethoxysilane, n-propyldimethoxysilane, isopropyldimethoxysilane, n-butyldimethoxysilane, sec-butyldimethoxysilane, tert-butyldimethoxysilane, isobutyldimethoxysilane, n-pentyldimethoxysilane, sec-pentyldimethoxysilane, tert-pentyldimethoxysilane, isopentyldimethoxysilane, neopentyldimethoxysilane, neohexyldimethoxysilane, cyclohexyldimethoxysilane, phenyldimethoxysilane, methyldiethoxysilane, ethyldiethoxysilane, n-propyldiethoxysilane, isopropyldiethoxysilane, n-butyldiethoxysilane, sec-butyldiethoxysilane, tert-butyldiethoxysilane, isobutyldiethoxysilane, n-pentyldiethoxysilane, sec-pentyldiethoxysilane, tert-pentyldiethoxysilane, isopentyldiethoxysilane, neopentyldiethoxysilane, neohexyldiethoxysilane, cyclohexyldiethoxysilane, phenyldiethoxysilane, trimethoxysilane, triethoxysilane, tri-n-propoxysilane, triisopropoxysilane, tri-n-butoxysilane, tri-sec-butoxysilane, tri-tert-butoxysilane, triphenoxysilane, allyltrimethoxysilane, allyltriethoxysilane, vinyltrimethoxsilane, vinyltriethoxysilane, (3-acryloxypropyl)trimethoxysilane, allyltrimethoxysilane, allyltriethoxysilane, vinyltrimethoxsilane, vinyltriethoxysilane, and (3-acryloxypropyl)trimethoxysilane. Of the above compounds, the preferred compounds are methyltrimethoxysilane, methyltriethoxysilane, methyltri-n-propoxysilane, methyltriisopropoxysilane, ethyltrimethoxysilane, ethyltriethoxysilane, dimethyldimethoxysilane, dimethyldiethoxysilane, diethyldimethoxysilane, and diethyldiethoxysilane.

The silica source may comprise a compound having the formula Si(OR²)₄ wherein R² independently represents a monovalent organic group. Specific examples of the compounds represented by Si(OR²)₄ comprise at least one of tetramethoxysilane, tetraethoxysilane, tetra-n-propoxysilane, tetraisopropoxysilane, tetra-n-butoxysilane, tetra-sec-butoxysilane, tetra-tert-butoxysilane, tetraacetoxysilane, and tetraphenoxysilane. Useful compounds may comprise at least one of tetramethoxysilane, tetraethoxysilane, tetra-n-propoxysilane, tetraisopropoxysilane, or tetraphenoxysilane.

The silica source may comprise a compound having the formula R³_{b}(R⁴O)_{3-b}Si—(R⁷)—Si(OR⁵)_{3-c}R⁶_{c}, wherein R³ and R⁶ are independently a hydrogen atom, a fluorine atom, or a monovalent organic group; R⁴ and R⁵ are independently a monovalent organic group; b and c may be the same or different and each is a number ranging from 0 to 2; R⁷is an oxygen atom, a phenylene group, a biphenyl, a naphthalene group, or a group represented by —(CH₂)ₙ—, wherein n is an integer ranging from 1 to 6; or combinations thereof. Specific examples of these compounds wherein R⁷ is an oxygen atom can comprise at least one member selected from the group of hexamethoxydisiloxane, hexaethoxydisiloxane, hexaphenoxydisiloxane, 1,1,1,3,3-pentamethoxy-3-methyldisiloxane, 1,1,1,3,3-pentaethoxy-3-methyldisiloxane, 1,1,1,3,3-pentamethoxy-3-phenyldisiloxane, 1,1,1,3,3-pentaethoxy-3-phenyldisiloxane, 1,1,3,3-tetramethoxy-1,3-dimethyldisiloxane, 1,1,3,3-tetraethoxy-1,3-dimethyldisiloxane, 1,1,3,3-tetramethoxy-1,3-diphenyldisiloxane, 1,1,3,3-tetraethoxy-1,3-diphenyldisiloxane, 1,1,3-trimethoxy-1,3,3-trimethyldisiloxane, 1,1,3-triethoxy-1,3,3-trimethyldisiloxane, 1,1,3-trimethoxy-1,3,3-triphenyldisiloxane, 1,1,3-triethoxy-1,3,3-triphenyldisiloxane, 1,3-dimethoxy-1,1,3,3-tetramethyldisiloxane, 1,3-diethoxy-1,1,3,3-tetramethyldisiloxane, 1,3-dimethoxy-1,1,3,3-tetraphenyldisiloxane and 1,3-diethoxy-1,1,3,3-tetraphenyldisiloxane. Useful compounds can comprise at least one of hexamethoxydisiloxane, hexaethoxydisiloxane, hexaphenoxydisiloxane, 1,1,3,3-tetramethoxy-1,3-dimethyldisiloxane, 1,1,3,3-tetraethoxy-1,3-dimethyldisiloxane, 1,1,3,3-tetramethoxy-1,3-diphenyldisiloxane, 1,3-dimethoxy-1,1,3,3-tetramethyldisiloxane, 1,3-diethoxy-1,1,3,3-tetramethyldisiloxane, 1,3-dimethoxy-1,1,3,3-tetraphenyldisiloxane; 1,3-diethoxy-1,1,3,3-tetraphenyldisiloxane. Specific examples of these compounds wherein R⁷ is a group represented by —(CH₂)ₙ— include: bis(trimethoxysilyl)methane, bis(triethoxysilyl)methane, bis(triphenoxysilyl)methane, bis(dimethoxymethylsilyl)methane, bis(diethoxymethylsilyl)methane, bis(dimethoxyphenylsilyl)methane, bis(diethoxyphenylsilyl)methane, bis(methoxydimethylsilyl)methane, bis(ethoxydimethylsilyl)methane, bis(methoxydiphenylsilyl)methane, bis(ethoxydiphenylsilyl)methane, 1,2-bis(trimethoxysilyl)ethane, 1,2-bis(triethoxysilyl)ethane, 1,2-bis(triphenoxysilyl)ethane, 1,2-bis(dimethoxymethylsilyl)ethane, 1,2-bis(diethoxymethylsilyl)ethane, 1,2-bis(dimethoxyphenylsilyl)ethane, 1,2-bis(diethoxyphenylsilyl)ethane, 1,2-bis(methoxydimethylsilyl)ethane, 1,2-bis(ethoxydimethylsilyl)ethane, 1,2-bis(methoxydiphenylsilyl)ethane, 1,2-bis(ethoxydiphenylsilyl)ethane, 1,3-bis(trimethoxysilyl)propane, 1,3-bis(triethoxysilyl)propane, 1,3-bis(triphenoxysilyl)propane, 1,3-bis(dimethoxymethylsilyl)propane, 1,3-bis(diethoxymethylsilyl)propane, 1,3-bis(dimethoxyphenylsilyl)propane, 1,3-bis(diethoxyphenylsilyl)propane, 1,3-bis(methoxydimethylsilyl)propane, 1,3-bis(ethoxydimethylsilyl)propane, 1,3-bis(methoxydiphenylsilyl)propane, and 1,3-bis(ethoxydiphenylsilyl) propane. Useful compounds can comprise bis(trimethoxysilyl)methane, bis(triethoxysilyl)methane, bis(dimethoxymethylsilyl)methane, bis(diethoxymethylsilyl)methane, bis(dimethoxyphenylsilyl)methane, bis(diethoxyphenylsilyl)methane, bis(methoxydimethylsilyl)methane, bis(ethoxydimethylsilyl)methane, bis(methoxydiphenylsilyl)methane and bis(ethoxydiphenylsilyl)methane.

In certain embodiments of the present invention, R¹ of the formula RₐSi(OR¹)₄₋ₐ; R² of the formula Si(OR²)₄; and R⁴ and/or R⁵ of the formula R³_{b}(R⁴O)_{3-b}Si—(R⁷)—Si(OR⁵)_{3-c}R⁶_{c} can each independently be a monovalent organic group of the formula: 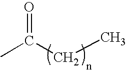
wherein n is an integer ranging from 0 to 4. Specific examples of these compounds can comprise at least one of tetraacetoxysilane, methyltriacetoxysilane, ethyltriacetoxysilane, n-propyltriacetoxysilane, isopropyltriacetoxysilane, n-butyltriacetoxysilane, sec-butyltriacetoxysilane, tert-butyltriacetoxysilane, isobutyltriacetoxysilane, n-pentyltriacetoxysilane, sec-pentyltriacetoxysilane, tert-pentyltriacetoxysilane, isopentyltriacetoxysilane, neopentyltriacetoxysilane, phenyltriacetoxysilane, dimethyldiacetoxysilane, diethyldiacetoxysilane, di-n-propyldiacetoxysilane, diisopropyldiacetoxysilane, di-n-butyldiacetoxysilane, di-sec-butyldiacetoxysilane, di-tert-butyldiacetoxysilane, diphenyldiacetoxysilane, triacetoxysilane. Useful compounds can comprise tetraacetoxysilane and methyltriacetoxysilane.

Other examples of the silica source may comprise at least one fluorinated silane or fluorinated siloxane such as those provided in U.S. Pat. No. 6,258,407; hereby incorporated by reference. Another example of the silica source may comprise compounds that produce a Si—H bond upon elimination.

In certain embodiments, the silica source comprises at least one carboxylic acid ester bonded to the Si atom. Examples of these silica sources comprise at least one of tetraacetoxysilane, methyltriacetoxysilane, ethyltriacetoxysilane, and phenyltriacetoxysilane. In addition to the at least one silica source wherein the silica source has at least one Si atom having a carboxylate group attached thereto, the composition may further comprise additional silica sources that may not necessarily have the carboxylate attached to the Si atom.

In some embodiments, a combination of hydrophilic and hydrophobic silica sources is used in the composition. The term “hydrophilic”, as used herein, refers to compounds wherein the silicon atom can crosslink through four bonds. In these embodiments, the ratio of hydrophobic silica source to the total amount of silica source can comprise at least about 0.5 molar ratio, or ranges from about 0.5 to about 100 molar ratio, or ranges from about 0.5 to about 25 molar ratio. Some examples of hydrophilic sources comprise alkoxysilanes having an alkoxy functionality and can at least partially crosslink, e.g., a Si atom with four methoxy, ethoxy, propoxy, acetoxy, etc. groups, or materials with carbon or oxygen bonds between Si atoms and all other functionality on the Si atoms being an alkoxide. If the Si atoms do not fully crosslink, residual Si—OH groups may be present as terminal groups that can adsorb water. The term “hydrophobic” refers to compounds where at least one of the alkoxy functionalities has been replaced with a Si—C or Si—F bond, e.g., Si-methyl, Si-ethyl, Si-phenyl, Si-cyclohexyl, among other compounds that would not generate an Si—OH after hydrolysis. In these sources, the silicon would crosslink with less than four bridges even when fully crosslinked as a result of hydrolysis and condensation of Si—OH groups if the terminal group remains intact. In certain embodiments, the hydrophobic silica source comprises a methyl group attached to the silicon atom.

The film-forming composition disclosed herein may optionally comprise at least one solvent. The term “solvent” as used herein refers to any liquid or supercritical fluid—besides water—that provides at least one of the following: solubility with the reagents, adjusts the film thickness, provides sufficient optical clarity for subsequent processing steps such as, for example, lithography, and/or may be substantially removed upon curing. The amount of solvent that may be added to the composition ranges from about 0% to about 65% by weight, or from about 0% to about 60% by weight, or from about 0% to about 50% by weight. Exemplary solvents useful for the film-forming composition can comprise at least one of alcohols, ketones, amides, alcohol ethers, glycols, glycol ethers, nitriles, furans, ethers, glycol esters, and/or ester solvents. The solvents could also have hydroxyl, carbonyl, or ester functionality. In certain embodiments, the solvent has one or more hydroxyl or ester functionalities such as those solvents having the following formulas: HO—CHR⁸—CHR⁹, —CH₂—CHR¹⁰R¹¹ where R⁸, R⁹, R¹⁰, and R¹¹ can be a CH₃ or H; and R¹²—CO—R¹³ where R¹² is a hydrocarbon having from 3 to 6 carbon atoms; R¹³ is a hydrocarbon having from 1 to 3 carbon atoms. Additional exemplary solvents comprise alcohol isomers having from 4 to 6 carbon atoms, ketone isomers having from 4 to 8 carbon atoms, linear or branched hydrocarbon acetates where the hydrocarbon has from 4 to 6 carbon atoms, ethylene or propylene glycol ethers, ethylene or propylene glycol ether acetates. Other solvents that can be used comprise at least one of 1 -propanol, 1-hexanol, 1-butanol, ethyl acetate, butyl acetate, 1-pentanol, 2-pentanol, 2-methyl-1-butanol, 2-methyl-1-pentanol, 2-ethoxyethanol, 2-methoxyethanol, 2-propoxyethanol, 1-propoxy-2-propanol, 2-heptanone, 4-heptanone, 1-tert-butoxy-2-ethoxyethane, 2-methoxyethylacetate, propylene glycol methyl ether acetate, pentyl acetate, 1-tert-butoxy-2-propanol, 2,3-dimethyl-3-pentanol, 1-methoxy-2-butanol, 4-methyl-2-pentanol, 1-tert-butoxy-2-methoxyethane, 3-methyl-1-butanol, 2-methyl-1-butanol, 2-methoxyethanol, 3-methyl-2-pentanol, 1,2-diethoxyethane, 1-methoxy-2 propanol, 1-butanol, 3-methyl-2-butanol, 5-methyl-2-hexanol, propylene glycol propyl ether, propylene glycol methyl ether, and γ-butyrolactone. Still further exemplary solvents comprise lactates, pyruvates, and diols. The solvents enumerated above may be used alone or in combination of two or more solvents. In certain embodiments wherein the film is formed by spin-on deposition, the film thickness of the coated substrate can be increased by lowering the amount of solvent present in the composition thereby increasing the solids content of the composition or, alternatively, by changing the conditions used to spin, level, and/or dry the film.

In alternative embodiments, the composition is substantially free of an added solvent or comprises about 0.01% by weight or less of an added solvent. In this connection, the composition described herein does not need an added solvent, for example, to solubilize the chemical reagents contained therein. The composition, however, may generate a solvent in situ (e.g., through hydrolysis of the reagents, decomposition of reagents, reactions within the mixture, among other interactions)

The film forming composition disclosed herein typically comprises water. In these embodiments, the amount of water added to the composition ranges from about 0.1% to about 30% by weight, or from about 0.1% to about 25% by weight. Examples of water that can be added comprise deionized water, ultra pure water, distilled water, doubly distilled water, and high performance liquid chemical (HPLC) grade water or deionized water having a low metal content.

At least one photoactive compound may be used in the film-forming composition described herein. The term “photoactive compound”, as used herein, describes at least one compound that interacts, absorbs, and/or is affected by exposure to an ionizing radiation source. In certain embodiments, the amount of photoactive compound in the composition may also influence the porosity and the dielectric constant of the film. The amount of photoactive compound added to the composition may range from about 0.0001% to about 35% by weight, or from about 1% to about 20% by weight, or from about 1% to about 10% by weight. The photoactive compounds useful in the present invention can comprise at least one of photoacid generators (“PAG”), photobase generators (“PBG”), and/or photosensitizers.

In certain embodiments, the photoactive compound comprises at least one PAG. The term “photoacid generator”, as used herein, describes a compound which liberates an acid upon exposure to an ionizing radiation source. In one embodiment, the ionizing radiation source comprises a photon source such as ultraviolet light at a wavelength of about 436 nanometers (nm) or less. Suitable PAGs can comprise at least one of halogenated triazines, onium salts, sulfonated esters, diaryliodonium salts, triazines, iodonium salts, sulfonium salts, diazomethanes, and/or halogenated sulfonyloxy dicarboximides. One particular example of a PAG comprises an onium salt having weakly nucleophilic anions. Examples of such anions can comprise at least one halogen complex anion of divalent to heptavalent metals or non-metals, for example, at least one of antimony, tin, iron, bismuth, aluminum, gallium, indium, titanium, zirconium, scandium, chromium, hafnium, copper, boron, phosphorus and arsenic. Examples of suitable onium salts can comprise at least one of diaryl-diazonium salts and onium salts of group VA and B, IIA and B and I of the Periodic Table, for example, at least one of halonium salts, quaternary ammonium, phosphonium and arsonium salts, aromatic sulfonium salts and sulfoxonium salts or selenium salts. Examples of suitable onium salts are disclosed in U.S. Pat. Nos. 4,442,197; 4,603,101; and 4,624,912, all incorporated herein by reference. Particular examples of an onium salt comprise at least one of triphenylsulfonium perfluorobutane sulfonate or nanoflate [Ph₃S]⁺[C₄F₉SO₃]⁻, bis(4-tert-butylphenyl) iodonium trifluoromethane sulfonate or triflate, or diphenyliodonium-9,10-dimethoxyanthracene-2-sulfonate. In other embodiments, the PAG comprises an sulfonated ester. The sulfonated esters useful as photoacid generators in the film-forming composition comprise sulfonyloxy ketones. Suitable sulfonated esters comprise at least one of benzoin tosylate, t-butylphenyl alpha-(p-toluenesulfonyloxy)-acetate, and t-butyl alpha-(p-toluenesulfonyloxy)acetate. Such sulfonated esters are disclosed in the Journal of Photopolymer Science and Technology, vol. 4, No. 3,337-340 (1991), incorporated herein by reference. In other embodiments, the PAG comprises a nonionic compound. Examples of suitable nonionic PAGs comprise at least one of N-Hydroxyphtalimide triflate, 2-(4-Methoxystyryl)-4,6-bis(trichloromethyl)-1,3,5-triazine, and N-hydroxy-5-norbornene-2,3-dicarboximide nanoflate.

In other embodiments, the photoactive compound comprises at least one photobase generator. The term “photobase generator”, as used herein, describes a compound which liberates a base upon exposure to an ionizing radiation source. Some examples of suitable PBGs comprise at least one of 2-nitrobenzyl cyclohexanecarbamate and triphenylsulfonium hydroxide.

In still further embodiments, the photoactive compound may comprise at least one photosensitizer. The photosensitizer can be used in combination with a PAG and/or PBG. The term “photosensitizer” as used herein describes a compound that absorbs energy from the ionizing radiation source at a certain criteria such as wavelength to allow a photoacid generator or a photobase generator to release its acid or its base, respectively. In one embodiment, the photosensitizer is used in combination with a PAG to enable the PAG to generate acid upon exposure to an ionizing radiation source such as ultraviolet light at wavelengths that it normally would not release an acid. For example, if a particular PAG does not absorb light at a wavelength range of about 300 nm or greater, the addition of one or more photosensitizers may allow the composition to generate acid upon UV exposure to this wavelength range. Examples of photosensitizers that are suitable for use herein are disclosed in U.S. Pat. Nos. 4,442,197, 4,250,053, 4,371,605, and 4,491,628; which are incorporated herein by reference. Particular examples of photosensitizers that may be used can comprise at least one of isopropyl-9H-thioxanthen-9-one (ITX), anthracene carbonitrile, anthracene methanol, the disodium salt of anthraquinone disulfonic acid, pyrene, and perylene.

In certain embodiments, the composition may optionally comprise a porogen that is incapable of forming a micelle in the composition. The term “porogen”, as used herein, comprises at least one chemical reagent that is used to generate void volume within the resultant film. Suitable porogens for use in the dielectric materials of the present invention can comprise at least one of labile organic groups, high boiling point solvents, decomposable polymers, dendrimeric polymers, hyper-branched polymers, polyoxyalkylene compounds, small molecules, and combinations thereof.

In certain embodiments of the present invention, the porogen may comprise at least one labile organic groups. When some labile organic groups are present in the reaction composition, the labile organic groups may contain sufficient oxygen to convert to gaseous products during the cure step. Some examples of compounds containing labile organic groups comprise the compounds disclosed in U.S. Pat. No. 6,171,945, which is incorporated herein by reference in its entirety.

In some embodiments of the present invention, the porogen may comprise at least one relatively high boiling point solvent. In this connection, the solvent is generally present during at least a portion of the cross-linking of the matrix material. Solvents typically used to aid in pore formation have relatively higher boiling points (e.g., about 170° C. or greater or about 200° C. or greater). Solvents suitable for use as a porogen within the composition of the present invention can comprise those solvents disclosed, for example, in U.S. Pat. No. 6,231,989, which is incorporated herein by reference in its entirety.

In certain embodiments, the porogen may comprise a small molecule such as those described in the reference Zheng, et al., “Synthesis of Mesoporous Silica Materials with Hydroxyacetic Acid Derivatives as Templates via a Sol-Gel Process”, J. Inorg. Organomet. Polymers, 10, 103-113 (2000) which is incorporated herein by reference, or quarternary ammonium salts such as tetrabutylammonium nitrate.

The porogen could also comprise at least one decomposable polymer. The decomposable polymer may be radiation decomposable, or typically, thermally decomposable. The term “polymer”, as used herein, also encompasses the terms oligomers and/or copolymers unless expressly stated to the contrary. Radiation decomposable polymers are polymers that decompose upon exposure to an ionizing radiation source, e.g., ultraviolet, X-ray, electron beam, among other sources. Thermally decomposable polymers undergo thermal decomposition at temperatures that approach the condensation temperature of the silica source materials and can be present during at least a portion of the cross-linking. Such polymers comprise those that may foster templating of the vitrification reaction, may control and define pore size, and/or may decompose and diffuse out of the matrix at the appropriate time in processing. Examples of these polymers comprise polymers that have an architecture that provides a three-dimensional structure such as those comprising block copolymers, e.g., diblock, triblock, and multiblock copolymers; star block copolymers; radial diblock copolymers; graft diblock copolymers; cografted copolymers; random copolymers, dendrigraft copolymers; tapered block copolymers; and combinations of these architectures. Further examples of decomposable polymers comprise the degradable polymers disclosed in U.S. Pat. No. 6,204,202, which is incorporated herein by reference in its entirety. Some particular examples of decomposable polymers comprise at least one of acrylates (e.g., polymethylmethacrylate methylacrylic acid co-polymers (PMMA-MAA) and poly(alkylene carbonates), polyurethanes, polyethylene, polystyrene, other unsaturated carbon-based polymers and copolymers, poly(oxyalkylene), epoxy resins, and siloxane copolymers).

The porogen may comprise at least one hyper-branched or dendrimeric polymer. Hyper-branched and dendrimeric polymers generally have relatively low solution and melt viscosities, high chemical reactivity due to surface functionality, and enhanced solubility even at higher molecular weights. Some non-limiting examples of suitable decomposable hyper-branched polymers and dendrimeric polymers are disclosed in “Comprehensive Polymer Science”, 2^{nd} Supplement, Aggarwal, pp. 71-132 (1996) that is incorporated herein by reference in its entirety.

The porogen within the film-forming composition may also comprise at least one polyoxyalkylene compound such as polyoxyalkylene non-ionic surfactants provided that the polyoxyalkylene non-ionic surfactants are incapable of forming a micelle in the composition, polyoxyalkylene polymers, polyoxyalkylene copolymers, polyoxyalkylene oligomers, or combinations thereof. An example of such comprises a polyalkylene oxide that includes an alkylene moiety ranging from C₂ to C₆ such as polyethylene oxide, polypropylene oxide, and copolymers thereof.

In certain embodiments, the composition may optionally comprise at least one base. In these embodiments, the base is added in an amount sufficient to adjust the pH of the composition to a range of from about 0 to about 7. In certain embodiments, the base may also catalyze the hydrolysis of substitutents from the silica source in the presence of water and/or the condensation of two silica sources to form an Si—O—Si bridge. Exemplary bases can comprise at least one of quaternary ammonium salts and hydroxides, such as ammonium or tetramethylammonium hydroxide, amines such as primary, secondary, and tertiary amines, and amine oxides.

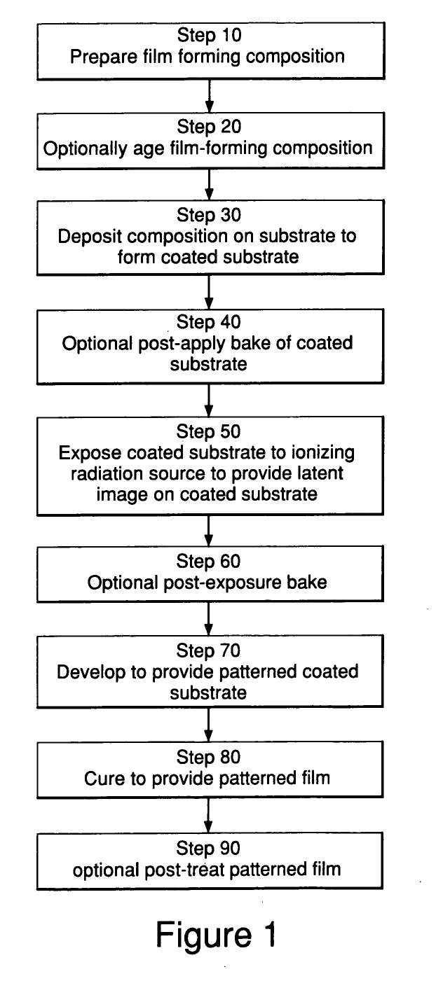

Referring now to FIG. 1, FIG. 1 shows a flow diagram of one embodiment of the method described herein that can be used for preparing a patterned film. As FIG. 1 illustrates, step 10 is preparing a film-forming composition. The composition may optionally be aged for a time period ranging from about 0.1 hour to about 180 days, or from about 0.1 hour to about 45 days, or from about 1 hour to about 72 hours, or from about 1 hour to about 48 hours. Step 20 of FIG. 1 is typically conducted at ambient temperature; however other temperatures may be used. Referring again to FIG. 1, in step 30, the film forming composition is deposited onto a substrate to provide a coated substrate. Depending upon the film formation method, the composition may be deposited onto a substrate as a fluid. The term “fluid”, as used herein, denotes a liquid phase, a gas phase, and combinations thereof (e.g., vapor) of the composition. The term “substrate”, as used herein, comprises any suitable composition that is formed before the dielectric film of the present invention is applied to and/or formed on that composition. Suitable substrates that may be used in conjunction with the present invention can comprise at least one of semiconductor materials such as gallium arsenide (“GaAs”), silicon, and compositions containing silicon such as at least one of crystalline silicon, polysilicon, amorphous silicon, epitaxial silicon, silicon dioxide (“SiO₂”), silica glass, silicon nitride, fused silica, glass, quartz, borosilicate glass, and combinations thereof. Other suitable substrates can comprise at least one of chromium, molybdenum, and other metals commonly employed in electronic devices, electronic displays, semiconductors, flat panel displays, and flexible display applications. The composition may be deposited onto the substrate via a variety of methods comprising at least one of dipping, rolling, brushing, spraying, extrusion, slot extrusion, spin-on deposition, printing, imprinting, and combinations thereof. Further exemplary deposition methods for step 30 of FIG. 1 comprise oscillating non-contact induced spreading forces, gravity-induced spreading forces, wetting-induced spreading forces and combinations thereof. In one particular embodiment, step 30 is conducted using a spin-on deposition method. In brief, the film-forming composition is typically dispensed onto a substrate and the solvent contained therein is evaporated to form the coated substrate. Further, centrifugal force is typically used to ensure that the composition is uniformly deposited onto the substrate.

In optional step 40 of FIG. 1, or a post-apply bake step, the coated substrate is exposed to an energy source such as thermal energy or other means to remove at least a portion of any solvent contained therein, if present, once the film-forming composition is deposited onto the substrate surface. This post-apply bake step may be conducted, for example, at a temperature ranging from about 30° C. to about 200° C., or from about 30° C. to about 150° C. for a time of from about 5 seconds to about 15 minutes on a hot plate or similar means. In certain embodiments, the coated substrate may be dried until the coating is substantially tack free. Similarly, in optional step 60 of FIG. 1, the exposed, coated substrate may be subjected to a further bake step, referred to herein as a “post-exposure bake”. In these embodiments, the post-exposure bake is typically conducted in a manner similar to the post-apply bake step.

In step 50 of FIG. 1, or the exposure step, the coated substrate is masked in a conventional manner and exposed to an ionizing radiation source sufficient to activate the photoactive compound(s) contained therein and may produce a latent image on at least a portion of the coated substrate. Examples of radiation sources that may be used comprise ultraviolet (UV) light (e.g.,, ranging from deep UV to near visible light), electron beam, x-ray, laser, and/or ion beams. The ionizing radiation source may have a wavelength range of from about 1 nanometer (nm) to about 700 nm, or from about 157 nm to about 500 nm. In embodiments wherein the ionizing radiation source comprises ultraviolet light, the exposure energy may range from about 1 to about 500 mJ/cm². However, this energy level is dependent upon the exposure tool and/or the components of the coating. The photodefinable material defined herein may be either a positive or a negative tone coating. In a positive tone coating, the areas masked from radiation remain after development while the exposed areas are dissolved away. In a negative tone coating, the opposite occurs. Depending upon whether the coating is positive or negative, the radiation either increases or decreases its solubility in a subsequently applied, developer solution.

In step 70 of FIG. 1, or the development step, a developer solution is applied to the exposed, coated substrate to produce a patterned coated substrate. The developer solution may comprise at least one of an aqueous solution, a non-aqueous solution, water; or a combination thereof. The term “aqueous solution” as used herein, describes a solution which comprises greater than about 50% by weight, about 75% by weight or greater, or about 90% by weight or greater water. The term “non-aqueous solution” as used herein describes a solution which comprises greater than about 50% by weight, or about 75% by weight percent or greater, or about 90% by weight or greater solvent wherein the solvent comprises any of the solvents described herein. In embodiments wherein the developer solution comprises water and solvent, the solvent is normally water miscible. The developer solutions typically comprise at least one base such as, for example, quaternary ammonium hydroxides such as tetramethylammonium hydroxide (TMAH), potassium hydroxide, sodium hydroxide, and combinations thereof. Further examples of developer solutions include those provided in U.S. Pat. Nos. 6,455,234; 6,268,115; 6,238,849; 6,127,101; and 6,120,978; hereby incorporated by reference. In certain embodiments, the coated substrate that may have a latent image is developed using water. The coated substrate may be developed by a variety of different means comprising at least one of quiescence, immersion, spray, or puddle development. In the quiescence method, for instance, a developer solution is applied to the coated substrate surface and after a period of time sufficient to develop the pattern, a rinse is then applied to the substrate surface. Development time and temperatures will vary depending upon the development method used.

In step 80 of FIG. 1, the patterned coated substrate is cured via at least one energy source such as, for example, thermal, electron-beam, ozone, plasma, X-ray, ultraviolet radiation, and combinations thereof to form the patterned film. Cure conditions such as time, temperature, and atmosphere may vary depending upon the method selected, the chemical reagents within the composition, the substrate, and/or the desired pore volume. In certain embodiments, the substrate is cured using a thermal energy source such as a hot plate, oven, furnace, among other sources. In certain embodiments, the cure steps may be conducted at two or more temperatures. In these embodiments, the first temperature, which may range from about 50 to about 400° C., or from about 50 to about 300° C., may be to remove any remaining water and/or solvent contained within the patterned substrate and to further cross-linking reactions. The second temperature may be to substantially, but not necessarily completely, cross-link the material. In other embodiments, the coated substrate is heated to at least one temperature ranging from about 50 to about 400° C., or about 400° C. or below. In these embodiments, the cure step is conducted for a time of about 30 minutes or less, or about 15 minutes or less, or about 10 minutes or less. In still other embodiments, the patterned coated substrate is heated using a controlled ramp or soak. In embodiments where thermal methods are used to cure the patterned coated substrate, curing may be conducted under controlled conditions such as atmospheric pressure using nitrogen, inert gas, air, or other N₂/O₂ mixtures (0-21% O₂), vacuum, or under reduced pressure having controlled oxygen concentration. In certain embodiments, the curing step is conducted via a thermal method in an air, nitrogen, or inert gas atmosphere, under vacuum, or under reduced pressure having an oxygen concentration of about 10% or lower.

In optional step 90 of FIG. 1, the patterned coated substrate may be further subjected to at least one post-cure treatment steps such as, for example, treatment with at least one energy source such as e-beam, UV, X-ray, ionizing radiation source and/or other energy sources described herein.

In certain embodiments, the photodefinable materials and films described herein comprise pores. In these embodiments, the photodefinable materials and films may be mesoporous, microporous, or combinations thereof. The term “mesoporous”, as used herein, describes pore sizes that range from about 10 Å to about 500 Å, or from about 10 Å to about 100 Å, or from about 10 Å to about 50 Å. The term “microporous” describes pore sizes that range from about 10 Å or less. In certain embodiments, the photodefinable film has a minimal number of pores. In alternative embodiments, the photodefinable film has pores of a narrow size range and the pores are homogeneously distributed throughout the film. Films may have a porosity ranging from about 1% to about 90%. The porosity of the films may be closed or open pore. In certain embodiments, the pore system may be sealed by atomic layer deposition.

In certain embodiments, the diffraction pattern of the photodefinable material or film does not exhibit diffraction peaks at a d-spacing greater than about 10 Angstroms. The diffraction pattern of the material or film may be obtained in a variety of ways such as, but not limited to, neutron, X-ray, small angle, grazing incidence, and reflectivity analytical techniques. For example, conventional x-ray diffraction data may be collected on a sample film using a conventional diffractometer such as a Siemens D5000 θ-θ diffractometer using CuKα radiation. Sample films may also be analyzed by X-ray reflectivity (XRR) data using, for example, a Rigaku ATX-G high-resolution diffraction system with Cu radiation from a rotating anode x-ray tube. Sample films may also be analyzed via small-angle neutron scattering (SANS) using, for example, a system such as the 30 meter NG7 SANS instrument at the NIST Center for Neutron Research. In alternative embodiments, the photodefinable material or film does exhibit diffraction peaks at a d-spacing greater than about 10 Angstroms.

The photodefinable material or film has mechanical properties that can allow the material, when formed into a film, to resist cracking and enable it to remain intact during subsequent processing, e.g. chemical mechanical planarization (CMP), sputtering, packaging, lamination, among other processing steps, while manufacturing an electronic device. Further, the films can exhibit relatively low shrinkage.

Photodefinable films described herein generally have a thickness that ranges from about 0.05 μm to about 5 μm, although lower thicknesses may be achieved. The photodefinable films described herein may exhibit a refractive index determined at about 633 nm of between about 1.1 and about 1.5. The dielectric constant is normally about 3.5 or less, or about 3.0 or less. The films described herein are thermally stable at temperatures of about 250° C. or greater. In certain embodiments, the film may be self-planarizing; or in alternative embodiments may planarize substrates or features on those substrates.

In certain embodiments, the photodefinable film exhibits a transmittance of about 50% or greater at a wavelength of about 193 nm or greater, or about 75% or greater at a wavelength of about 248 nm or greater, or greater than about 90% at a wavelength of about 365 nm or greater, and greater than about 98% at a wavelength of about 400 nm or greater.

The photodefinable materials and films described herein are suitable for use within electronic devices. The films described herein can provide excellent insulating properties. The film can also provide advantageous uniformity or planarization, dielectric constant stability, cracking resistance, and/or adhesion to the underlying substrate and/or other films. Suitable applications for the patterned film comprise interlayer insulating films for semiconductor devices such as LSIs, system LSIs, DRAMs, SDRAMs, RDRAMs, and D-RDRAMs, protective films such as surface coat films for semiconductor devices, interlayer insulating films for multilayered printed circuit boards, protective or insulating films for liquid-crystal display devices, substrate planarization films for OLEDs or other displays, gate dielectrics for thin film transistors, or a planarizing insulating film for thin film transistors in display, imaging, among other electronic devices.

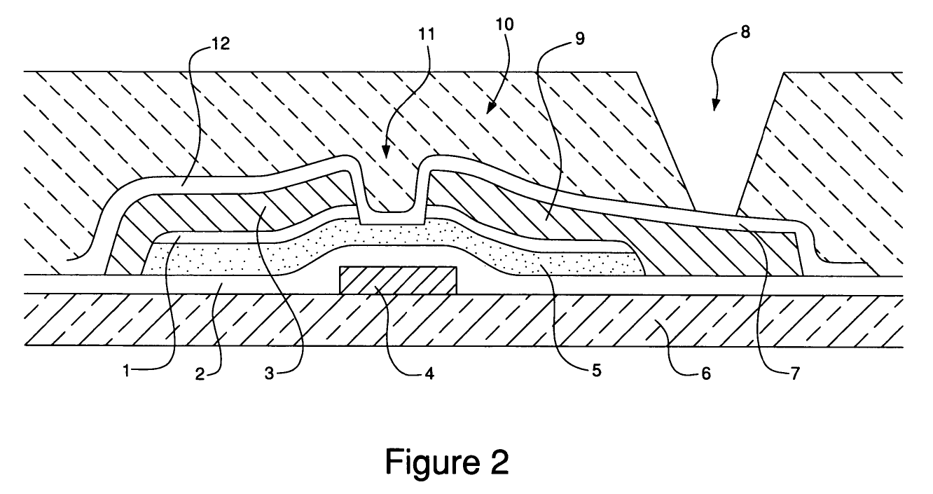

A particular embodiment of the insulating materials and films described herein comprises a super high aperture (SHA) or aperture enhancing layer for thin film transistors (TFTs). These thin film transistors form a transistor array that may be used as backplanes for displays, imaging and sensor devices, and other applications. An example of a cross-section of a representative transistor covered by an photodefinable dielectric SHA film is illustrated in FIG. 2. Referring now to FIG. 2, FIG. 2 illustrates a photodefinable dielectric film of the invention is labeled as 10, the passivation layer is labeled as 7 and 12, and the components of the thin film transistor are labeled as 1-5, 7, 9, and 12. The doped silicon semiconductor is labeled as 1, the gate insulator is labeled as 2, the drain electrode is labeled as 3, the gate electrode is labeled as 4, the silicon semiconductor is labeled as 5, and the substrate is labeled as 6 and is frequently, but not always, glass. The via or contact hole for the contact electrode is labeled as 8, the source electrode is labeled as 9, the planarizing, photodefinable dielectric SHA film is labeled as 10, and the transistor channel is labeled as 11.

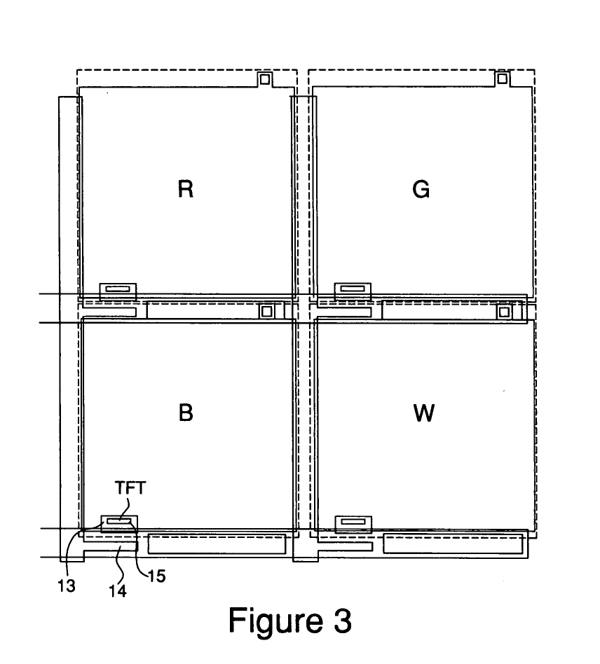

Referring now to FIG. 3, FIG. 3 shows a top-down view of a thin film transistor array that may be used with liquid crystal, OLED, or electrophoretic displays. This figure illustrates pixel electrodes overlapping surrounding row and column address lines along their respective lengths throughout the display's pixel area so as to increase the pixel aperture ratio of the display. This aperture increase corresponds to an increase in brightness of the display given the same power input. In FIG. 3, the source electrode is labeled as 13, the drain electrode as 14, and the contact hole or via is labeled as 15. In the case of a liquid crystal display, the display driven by such a thin film transistor array is often referred to as an active matrix liquid crystal display (AMLCD).

Further non-limiting applications comprise photonics, nano-scale mechanical or nano-scale electrical devices, gas separations, liquid separations, or chemical sensors. Still further applications for the materials and films described herein can comprise at least one of flat panel displays, flexible displays, photovoltaics, solar cells, integrated circuits, memory manufacturing, RFID tags, sensors, smart objects, X-ray imaging or other imaging devices, among other devices. In the area of flat panel displays, liquid crystal displays (LCDs) and organic light emitting diodes (OLEDs) or polymeric light emitting diodes (PLEDs) may be driven by backplanes containing thin film transistor (TFT) arrays that may comprise the materials and films described herein and be described as active matrix liquid crystal displays (AMLCD), active matrix organic light emitting devices (AMOLED), or active matrix polymer light emitting devices (AMPLED), respectively. Electrophoretic displays may also be driven by such backplanes.

### EXAMPLES

In the following examples, unless stated otherwise, exemplary films were deposited onto four inch prime silicon low resistivity (<0.009 Ω cm) wafers and lithographically processed in the following manner. Unless stated otherwise, the deposition process was conducted by dispensing 1 milliliter (mL) of the composition through a 0.2 micron (μm) Teflon filter and the wafer was spun on a rotating turntable for 7 seconds at 500 revolutions per minute (rpm) and then ramped to 1800 rpm for 40 seconds to form a coated substrate. The wafers were spun on a Model WS-400A-8-TFM/LITE rotating turntable manufactured by Laurell Technologies Corporation of North Wales, Pa.

After the coated substrates were prepared, unless stated otherwise, a mask that consisted of a thin metal plate or a silicon wafer was placed on the coated substrate and the unmasked portion of the coated substrate was exposed to an ionizing radiation source. The exposed coated substrates were then developed using one of the following solutions: an aqueous 0.26 N TMAH developer or OPTIYIELD™ manufactured by Air Products and Chemicals Inc. of Allentown, Pa., an aqueous 0.26 N TMAH developer or AZ300 MIF manufactured by Clariant Ltd. of Basel, Switzerland; or water. The exemplary films were then cured using either a Cimarec Model No. 2 or Cimarec Model No. 3 hot plate manufactured by Thermolyne to provide a patterned film. On top of each hot plate was an aluminum plate with a thermocouple inserted into a hole in each plate for monitoring the temperature and relaying the temperature to a controller. The temperature of each hot plate was controlled by a temperature controller R/S Digisense temperature controller sold by Cole-Parmer.

The exemplary films were observed by various compound optical microscopes and under a JSM-5910LV or a JSM-6300F scanning electron microscope (SEM) manufactured by JEOL to detect latent or patterned images. The accelerating voltage used to examine the specimens ranged between 2-5 kV. Prior to observation, the exemplary films were sometimes coated with approximately 6 nanometers of Au/Pd prior to SEM examination to improve the sample conductivity and enhance the signal to noise ratio of the secondary electron image.

The thickness, film refractive index, and porosity values of each film were determined by spectroscopic ellipsometry using a variable angle spectroscopic ellipsometer, Model SE 800 manufactured by Sentech Instruments GmbH, and calculated by SpectraRay software. The refractive index and film thickness were obtained by simulating the measurement using various models such as Bruggemann in the wavelength range from 400 to 800 nm with mean square error of about 1 or less. For the thickness values, the error between the simulated thickness and actual film thickness values measured by profilometry was generally less than 2%.

The dielectric constant of each exemplary film was determined according to ASTM Standard D150-98. The capacitance-voltage of each film were obtained at 1 MHz with a Solartron Model SI 1260 Frequency Analyzer and MSI Electronics Model Hg 401 single contact mercury probe. The error in capacitance measurements and mercury electrode area (A) was less than 1%. The substrate (wafer) capacitance (C_{Si}), background capacitance (C_{b}) and total capacitance (C_{T}) were measured between +20 and −20 volts and the thin film sample capacitance (Cₛ) was calculated by Equation (1):
Cₛ=C_{Si}(C_{T}−C_{b})/[C_{Si}−(C_{T}−C_{b})] Equation (1)

The dielectric constant of each film was calculated by Equation (2) wherein d is the film thickness, A is the mercury electrode area, and eo is the dielectric constant in vacuum:

$$ɛ = \frac{{C}_{S} d}{{ɛ}_{0} A} \qquad Equation ( 2 )$$

The total error of the dielectric constant of the film was expected to be less than 6%.

### Examples 1a and Comparative 1b

### Photodefinable Film and Comparative Film Using Triphenylsulfonium Nanoflate PAG

A composition was prepared by adding 2.25 grams of a 50/50 weight % mixture of TEOS and MTES, 5.0 grams of the solvent propylene glycol propyl ether (PGPE), 0.265 grams of the PAG Triphenylsulfonium Nanoflate ([Ph₃S]⁺[C₄F₉SO₃]⁻), and 0.9 grams of water. The composition was briefly shaken and then aged for approximately 2 hours at room temperature and then deposited onto silicon wafers. The deposition and masking was conducted as described above. The unmasked portion of both films, 1a and 1b, were then exposed to a broad band ultraviolet light source referred to herein as “UV1”, manufactured by Fusion Systems using a “D” bulb, for 5 seconds. After UV exposure, film 1a was then developed using an aqueous 0.26 N TMAH developer solution for 30 seconds. The wafer was removed from the bath and rinsed with water. After processing, the wafer only contained the exposed film with the proper negative image also described as a patterned coated substrate.

After exposure, exemplary film 1b was soft-baked at 180° C. Exemplary film 1b was then developed using an aqueous 0.26 N TMAH developer solution for 30 seconds. The wafer was removed from the bath and rinsed with water. After rinsing, the wafer had a film on both the exposed and the unexposed regions. Film 1a and 1b were both cured using a hot plate in air at 180° C. for 90 seconds, and 400° C. for 3 minutes. Films 1a and 1b exhibited thicknesses of 100 nm and 56 nm, respectively, and refractive indices of 1.3007 and 1.3632, respectively. A dielectric constant value of 2.47 was obtained for film 1a; a dielectric constant could not be measured for film 1b.

### Example 2

### Photodefinable Film Using the PAG Bis(4-tert-butylphenyl)iodonium) Triflate

Exemplary films 2a through 2f were deposited, exposed, and developed in accordance with the method described in Example 1a except the film-forming composition contained the following: 2.25 grams of 50/50 weight % mixture of TEOS and MTES, 4.77 grams of the solvent PGPE, 0.693 grams of the PAG (Bis(4-tert-butylphenyl)iodonium) triflate, and 1.2 grams of water. After processing, the wafers contained the exposed film with the proper negative image. Films 2a through 2c were cured using hot plates in air at 90° C. for 90 seconds, and 180° C. for 90 seconds, and 400° C. for 3 minutes, respectively. Films 2a through 2c had thicknesses of 498, 495, and 494 nm; dielectric constant values of 3.0, 3.0, and 2.9; and refractive indices of 1.278, 1.277, and 1.274, respectively. Films 2d through 2f were cured at a maximum temperature of 250° C. for 3 minutes and had thicknesses of 476, 479, and 507 nm; dielectric constant values of 3.2, 3.0, and 3.2; and refractive indices of 1.289, 1.290, and 1.286, respectively.

### Example 3

### Development of a Photodefinable Film Using Water

Exemplary films 3a through 3c were prepared in accordance using the same composition as Example 2 except that the films 3a and 3b were developed using water as the developer solution rather than the aqueous 0.26 N TMAH developer solution. The wafers were removed from the water bath and rinsed with water. As a result of this processing, the wafers only contained the exposed film with the proper negative image. Exemplary film 3c was developed in the aqueous 0.26 N TMAH developer solution as described in Example 1a. The resultant films 3a through 3c were cured on a hot plate in air at 90° C for 90 seconds, 180° C. for 90 seconds, and 400° C. for 3 minutes. Films 3a though 3c exhibited thicknesses of 524, 536 and 512 nm; refractive indices of 1.2674, 1.2693 and 1.2759; and dielectric constant values of 3.5, 3.5 and 2.9, respectively.

### Example 4

### Effect of UV Light Source and PAG Choice on Photodefinability

The present experiment was conducted to determine if a porous organosilicate film can be made photodefinable using a UV source having a wavelength of 300 or greater in combination with certain photoactive compound or PAG. The same composition containing the PAG (Bis(4-tert-butylphenyl)iodonium) triflate and experimental conditions described in Example 2 was repeated except that a different UV light source, referred to herein as “UV2”, or a UV Flood exposure tool by Optical Associates Inc. containing a 500 Watt Hg short arc lamp capable of only generating light at a wavelength above 300 nm, was used in conjunction with an i-line filter. The i-line filter allows only approximately 300-400 nm light to pass through it. Films made from this formulation were not photodefinable when UV2 is the UV light source and the PAG selected is one that is activated at wavelengths below 300 nm. Without wishing to be bound by any theory or explanation, it is believed that since this particular PAG does not absorb light in this region, it does not generate acid upon irradiation and silicate condensation does not occur. It was observed that both the exposed and unexposed region of these films dissolved when placed in the aqueous 0.26 N TMAH developer solution.

### Example 5

### Photodefinable Film Prepared with a PAG That Activates at a Wavelengths Between Approximately 300 nm and 400 nm

Example 2 was repeated except for the following: the composition contained the photoactive compound, PAG (4-Phenylthiophenyl)-diphenylsulfonium triflate with a λₘₐₓ=298 nm, instead of (Bis(4-tert-butylphenyl)iodonium) triflate. The film was masked to reveal a portion of the film and then exposed to the UV2 light source. During the exposure, the shutter on the UV2 light source was opened for 15 seconds. The film was then rinsed with water followed by the aqueous 0.26 N TMAH developer. As a result of this processing, the wafers only contained the exposed film with the proper negative image. The resultant film was cured under the conditions described in Examples 2a through 2c and the resultant patterned film had a thickness of 542 nm, a dielectric constant value of 2.7, and a refractive index of 1.2883.

### Comparative Example 1

### Organosilicate Film Prepared Without PAG

The following reagents were mixed and allowed to age overnight or for approximately 12-16 hours: 0.75 g of a 50/50 weight % mixture of TEOS/MTES, 1.67 g of PGPE, and 0.4 g of 0.1 M HNO₃ catalyst. This composition was deposited onto the silicon wafer substrate by dispensing 1 ml of the solution through a 0.2 micron Teflon filter. The wafer was spun on a rotating turntable for 7 seconds at 500 rpm and ramped to 1800 rpm for 40 seconds to form a film. The film was masked to reveal a portion of the film and then exposed to the UV1 light source for 5 seconds. The film was then developed using an aqueous 0.26 N TMAH developer solution for 30 seconds. The entire film dissolved in the developer solution leaving a bare wafer with no film remaining.

### Comparative Example 2

### Porous Organosilicate Film Prepared with Surfactant as a Porogen with No PAG

The following reagents were mixed and allowed to age overnight or approximately 12-16 hours: 0.75 g of a 50/50 weight % mixture of TEOS/MTES, 1.767 g of PGPE and 0.4 g of 0.1 M HNO₃ catalyst, and 0.161 g of the surfactant TRITON™ X114 sold by Aldrich Chemicals, Inc. The composition was deposited onto a silicon wafer substrate by dispensing 1 ml of the solution through a 0.2 micron Teflon filter. The wafer was then spun on a rotating turntable for 7 seconds at 500 rpm and then 1800 rpm for 40 seconds. The resultant film was cured on a hot plate in air at 90° C. for 90 seconds, 180° C. for 90 seconds, and 400° C. for 3 minutes. The resultant film, Comp. Ex. 2a, exhibited a thickness of 495 nm, a refractive index of 1.2366, and a dielectric constant value of 1.92.

A second film, Comp. Ex. 2b was prepared in the same manner as Comp. Ex. 2a, except that it was masked and exposed to the UV1 source for 5 seconds. The film was developed using an aqueous 0.26 N TMAH developer solution for 30 seconds. This film dissolved in the developer solution leaving a bare wafer.

A third film was spun, Comp. Ex. 2c was exposed to the UV1 for 15 seconds, and was baked under the same conditions as the Comp. Ex. 2a. The resultant film exhibited a thickness of 476 nm, a dielectric constant value of 2.2, and a refractive index of 1.2385.

### Example 6

### Mixed PAG System Irradiated at Approximately 300nm to 400 nm

A film-forming composition was prepared, deposited, exposed, and cured in the same manner as Example 4 except that the composition contained 0.55 of bis(4-tert-butylphenyl)iodonium) triflate and 0.14 of diphenyliodonium-9,10-dimethoxyanthracene-2-sulfonate (DIAS) as the photoactive compound rather than the PAG, bis(4-tert-butylphenyl)iodonium) triflate, alone. Compared to Example 4, the addition of a small amount of diphenyliodonium-9,10-dimethoxyanthracene-2-sulfonate (DIAS) led to a photodefinable film when exposed to the UV2 source for 15 seconds as described in Example 4. The film was developed by rinsing the film with deionized water for approximately 15 to 30 seconds and then placed in an aqueous 0.26 N TMAH developer solution for 30 seconds. The wafer was removed from the bath and rinsed with deionized water. After processing the wafer, the exposed film with the proper negative image was the only portion left on the wafer.

Exemplary films 6a and 6b were spun from the above composition after aging the composition for 5 or 8 days, respectively. Both films were cured on hot plates in air at 90° C. for 90 seconds, 180° C. for 90 seconds, and 400° C. for 3 minutes. Exemplary film 6a had a thickness of 365 nm, a dielectric constant value of 2.5, and a refractive index of 1.2836. Exemplary film 6b had a thickness of 500 nm, a dielectric constant value of 3.35, and a refractive index of 1.3307.

### Example 7

### Contact Lithography at 300 nm or Greater

A film-forming composition was prepared containing the following: 4.5 grams of 50/50 weight % mixture of TEOS and MTES, 9.54 grams of the solvent PGPE, 1.1 grams of the PAG (Bis(4-tert-butylphenyl)iodonium) triflate, 0.28 g of diphenyliodonium-9,10-dimethoxyanthracene-2-sulfonate (DIAS), and 2.4 grams of water. The composition was prepared and allowed to age at ambient temperature for 8 days before the films described below were spun.

The same spin conditions described in Example 2 using a CEE Model 100 spinner were used to produce exemplary films 7a and 7b on silicon wafers. The coated substrates were exposed to UV light using a Hybrid Technology Group's (HTJ) system 3 HR contact/proximity mask aligner that was equipped with a 405 nm mirror. This system uses a mercury (Hg) tube which emits light over the broad emission spectrum. The power measured at 365 nm was 14 mWatts/cm². The test mask used had patterns with features in sizes ranging from 7.5μ-1.0μ. Films 7a and 7b were exposed to UV light at 7 different locations on the film. The exposure times for the exemplary films 7a and 7b were 0.1, 0.3, 0.5, 0.8, 2, 5, and 10 seconds. The exemplary films were placed under a deionized water rinse for approximately 15 seconds. As a result of this water processing, the wafers only contained the exposed film with the proper negative image. The patterned films were then placed in an aqueous 0.26 N TMAH developer solution for 30 seconds and rinsed with deionized water to remove the developer solution from the film. The wafers were then cured on a hot plate in air at 90° C. for 90 seconds. Analysis of each film was conducted using optical microscope. The analysis showed that lines and spaces on the exemplary films were resolved down to approximately 1.8μ (e.g., no residue between lines or in trenches) at an exposure time of 0.8 seconds. Cross-sectional cuts were made on exemplary film 7a and scanning electron microscope (SEM) images were obtained. These images show good adhesion of the film to the Si substrate below with no signs of swelling during development and no undeveloped resin in between the lines or left in the trenches or contact holes. The features were found to have highly tapered walls.

### Example 8

### Use of an i-line Stepper as an Ionizing Radiation Source

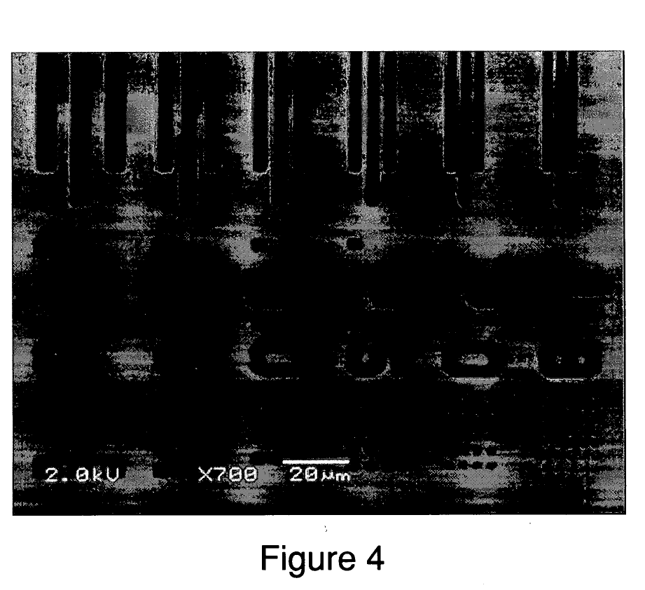

Exemplary films 8a through 8f were prepared using the same composition and deposition conditions as provided in Example 7. The exemplary films were exposed to an UV light source that was a GCA-6300 DSW projection mask aligner 10X i-line stepper. The stepper used 365 nm light which reduces the feature sizes from the mask 10 times in size after light passes through the mask and through a series of optics. The test mask used had patterns with features in the size range of 5μ down to 0.5μ. Film 8a was exposed to UV light at 49 different locations on the film, at each location a different dose of UV was applied. The first pattern started at 7.5 mJ/cm² and the dose was stepped in increments of 7.5 mJ/cm² until a dose of 367.5 mJ/cm² was reached (last pattern). This film was then placed under a deionized water rinse for approximately 15 seconds. As a result of this water processing, the wafers only contained the exposed film with the proper negative image. The patterned film was then placed in an aqueous 0.26 N TMAH developer solution for 30 seconds, removed and rinsed with deionized water to remove the TMAH developer solution from the film. The wafer was then cured on hot plates in air at 90° C. for 90 seconds, 180° C. for 90 seconds, and finally 250° C. for 6 minutes. Optical and SEM images were taken of the film at an exposure dose of 166 mJ/cm². Referring now to FIG. 4, FIG. 4 is an SEM of a film formed in accordance with this Example. Lines and spaces were resolved down to 1.8 μm (no residue between lines or in trenches). Cross sectional cuts were made on 8a and images were obtained by SEM. These images show good adhesion of the film to the Si substrate below and showed no signs of swelling during development. There is no undeveloped resin in between the lines or remaining in the trenches or contact holes. The features were found to have highly tapered walls. The initial dose first pattern for films 8b though 8f started at 75 mJ/cm² and the dose was stepped in increments of 4.5 mJ/cm² until a dose of 291 mJ/cm² was reached (last pattern). These films were then developed the same way as exemplary film 8a. An optical microscope was used to determine that these films resolved well between dose levels of 115.5-178.5 mJ/cm².

### Example 9

### Use of Photosensitizer with a PAG

A film-forming composition was prepared containing the following: 1.125 grams of 50/50 weight % mixture of TEOS and MTES, 2.385 grams of the solvent PGPE, 0.342 grams of the PAG (Bis(4-tert-butylphenyl)iodonium) triflate, 0.005 grams of the photosensitizer isopropyl-9H-thioxanthen-9-one (ITX) (a mixture of 2- and 4-isomers), and 0.6 grams of water.

This film-forming composition was deposited, exposed, and cured in the same manner as Example 4. Compared to Example 4, the addition of a small amount of photosensitizer isopropyl-9H-thioxanthen-9-one (ITX) led to a photodefinable film when exposed to the UV2 source for 15 seconds as described in Example 4. The film was developed by rinsing the wafer in deionized water for 30 seconds followed by letting the solution stand in a crystallizing dish containing an aqueous 0.26 N TMAH developer solution for 30 seconds. The wafer was removed from the bath and rinsed with deionized water. After processing the wafer, the exposed film with the proper negative image was obtained. The film was cured on a hot plate in air at 90° C. for 90 seconds, 180° C. for 90 seconds, and finally 400° C. for 3 minutes. The resultant film was 217 nm thick and had a dielectric constant of 2.9.

### Comparative Example 3

### Nonphotodefinable Organosilicate Film Prepared Without PAG

The following ingredients were mixed and allowed to age either at room temperature for 7 days, Comp. Ex. 3a, or at 60° C. for 2 hours, Comp. Ex. 3b: 2.25 g of a 50/50 weight % mixture of TEOS/MTES, 4.77 g of PGPE, and 1.2 g of deionized water. Comp. Ex. 3a led to a heterogeneous solution while Comp. Ex 3b led to a homogeneous solution. The compositions were deposited onto silicon wafers by dispensing 1 ml of the composition through a 0.2 micron Teflon filter. Each wafer was then spun for 7 seconds at 500 rpm then ramped to 1800 rpm for 40 sec. No exposure or development step was conducted on films from either Comp. Ex. 3a or Comp. Ex. 3b. A relatively small amount of material was left on the wafer from Comp. 3a while a useful film was made from Comp. 3b. The exemplary film from Comp. 3b was baked on hot plates at 90° C. for 90 seconds, 180° C. for 90 seconds, and then 400° C. for 3 minutes, which led to a nonphotodefinable 0.329 micron film with a dielectric constant of 5.6 and a refractive index of 1.4018. A second exemplary film from Comp 3b was spun and exposed to the UV1 source for 10 seconds. The film was then rinsed in deionized water. This film dissolved in water leaving a bare wafer.

### Example 10

### Swelling Experiments

A film-forming composition used in Example 6 was prepared and aged for 6 days, deposited, exposed, developed and cured in the same manner as Example 6. After the samples had been baked, film properties were measured. The films were placed in different baths containing various solvents at ambient temperature for 1 hr or in a constant temperature/humidity oven at 85° C. and 85% humidity for 2 hours. After exposure to solvents, the films were allowed to air dry for 0.5 hour then were baked on hot plates at 400° C. for 2 minutes. After the final bake, the film properties were re-measured and the results are listed in the Table 1 below. The conditions described in the “Treatment” column of Table 1 below are treatment with solvent or heat treatment. In the cases of solvent treatment, some commonly used solvents were employed such as isopropyl alcohol (IPA), propylene glycol monoethyl alcohol (PGMEA), hexanes, and n-methylpyrrolidone (NMP). The heat treatment used for these films was a temperature condition of 85° F./85% relative humidity (85/85 oven). Referring to Table 1, no swelling occurred as indicated by comparing the thickness measurements before and after treatment.

TABLE 1

| | | Dielectric | | | | Dielectric | |
|---|---|---|---|---|---|---|---|
| | Thickness | Constant | R.I. | | Thickness | Constant | R.I. |
| | Before | Before | Before | | After | After | After |
| Example | treatment | Treatment | Treatment | Treatment | treatment | Treatment | Treatment |
| Ex. 10a | 0.2657 | 2.21 | 1.2409 | Control | 0.2671 | 2.21 | 1.2394 |
| | | | | (no solvent) | | | |
| Ex. 10b | 0.2730 | 2.18 | 1.2295 | IPA | 0.2685 | 2.12 | 1.2262 |
| Ex. 10c | 0.2738 | 2.25 | 1.2305 | PGMEA | 0.2703 | 2.16 | 1.2253 |
| Ex. 10d | 0.2730 | 2.20 | 1.2229 | Hexanes | 0.2726 | 2.17 | 1.2215 |
| Ex. 10e | 0.2773 | 2.24 | 1.2281 | NMP | 0.2719 | 2.15 | 1.2220 |
| Ex. 10f | 0.2728 | 2.19 | 1.2314 | 85/85 oven | 0.2706 | 2.23 | 1.2300 |

### Example 11

### Photodefinable Film Prepared with PAG Active at 157-248 nm with and without Surfactant

Four film-forming compositions were prepared using the ingredients provided in Table 2 below, deposited onto silicon wafers, exposed to the UV1 light source, and developed as described in Example 2. The films made from solutions containing surfactant, or Examples 11b and 11c, dissolved completely in the developer solution (both exposed and unexposed regions) leaving a bare substrate. Exemplary films made from composition 11a had the proper negative image. Exemplary films made from composition 11d were developed in water rather than the aqueous 0.26 N TMAH developer solution. After processing, the exposed film with the proper negative image was obtained. This film was cured as described in Example 2a-2c and a thickness of 67 nm was measured.

TABLE 2

| | Ex. 11a | Ex. 11b | Ex. 11c | Ex. 11d |
|---|---|---|---|---|
| TEOS/MTES(50/50) | 0.375 | 0.375 | 2.25 | 2.25 |
| PGPE | 0.792 | 0.792 | 4.77 | 4.77 |
| PAG | 0.088⁽¹⁾ | 0.088⁽¹⁾ | 0.173⁽²⁾ | 0.173⁽²⁾ |
| H₂O | 0.2 | 0.2 | 1.2 | 1.2 |
| Triton X114 | 0.0 | 0.018 | 0.363 | 0.0 |
| Brij 56 | 0.0 | 0.0 | 0.0 | 0.363 |

⁽¹⁾(Bis(4-tert-butylphenyl)iodonium) triflate
⁽²⁾(4-Phenylthiophenyl)diphenylsulfonium triflate

### Example 12

### Photodefinable Film Prepared with PBG Active at 157-248 nm

A film forming composition was prepared containing the following: 0.75 grams of 50/50 weight % mixture of TEOS and MTES, 1.75 grams of the solvent PGPE, 0.22 grams of the PBG 2-nitrobenzyl cyclohexanecarbamate, and 0.4 grams of water. The composition was prepared and left to age at ambient temperature for 4 days before the films were deposited. The composition was deposited onto silicon wafers, exposed to the UV1 light source, and developed as described in Example 2. The exposed film area all remained and almost all the unexposed region was removed thereby giving the proper negative tone image.

### Example 13

### Photodefinable Film Prepared with PBG2 Active at 157-248 nm

Example 12 was repeated except the film-forming composition contained 0.022 grams of the PBG2, triphenylsulfonium hydroxide, as the photoactive compound rather than 0.22 of the PBG 2-nitrobenzyl cyclohexanecarbamate. After exposure to the UV1 source, the film was not optically transparent. The film was developed using water for 30 seconds. The exposed film with the proper negative image was obtained.

### Example 14

### Photodefinable Film Containing PAG and Photosensitizer and Exposed at Wavelengths From 300 to 400 nm

In Example 14a, a film-forming composition was prepared containing the following: 3.0 grams of MTES as the silica source, 6.36 grams of the solvent PGPE, 0.734 grams of the PAG (Bis(4-tert-butylphenyl)iodonium) triflate, 0.186 grams of the photosensitizer isopropyl-9H-thioxanthen-9-one (ITX) (a mixture of 2- and 4-isomers) and 1.6 grams of water. The composition was aged 7 days and then deposited, exposed, developed and cured in the same manner as Example 6. The wafer contained a layer of residue, which volatilized away during the cure step at 180° C. The exposed film with the proper negative image was obtained. The resultant film was 587 nm thick and had a dielectric constant value of 2.32.

In Example 14b, a composition was prepared in the following manner. 9.0 grams of MTES as the silica source, 19.08 grams of the solvent PGPE, 2.202 grams of the PAG (Bis(4-tert-butylphenyl)iodonium) triflate, 0.558 grams of the photosensitizer isopropyl-9H-thioxanthen-9-one (ITX) (a mixture of 2- and 4-isomers) and 3.0 grams of water. On day four, 0.3 g of water was added containing 0.0011 g of tetramethylammonium hydroxide. The composition was aged 28 days and then deposited, exposed, developed and cured in the same manner as Example 6. The exposed film with the proper negative image was obtained. The exemplary film 15b was 570 nm thick and had a dielectric constant value of 2.28. The composition was aged 31 days and then deposited, exposed, developed and cured on hot plates in air at 90° C. for 90 seconds, 180° C. for 90 seconds, and 250° C. for 6 minutes. The exposed film with the proper negative image was obtained. The exemplary film 15c was 550 nm thick and had a dielectric constant value of 2.50.

### Example 15

### Composition Comprising Thermally Decomposable Polymer to Increase the Thickness of the Film

In Example 15a, a composition was prepared in the following manner. A solution was prepared containing 1 g of polymethylmethacrylate methylacrylic acid co-polymer (PMMA-MAA) dissolved in 12 g of PGPE. A quantity of 0.73 g of (bis(4-tert-butylphenyl)iodonium) triflate (PAG) was added to 6.4 grams of the solution until it dissolved. Next, 0.19 g of the photosensitizer isopropyl-9H-thioxanthen-9-one (ITX) was dissolved in the solution. After all of the reagents had completely dissolved in the solution, 1.6 g of deionized water and 3 g of methyltriethoxysilane (MTES) were then added. The solution was shaken for approximately 1 to 2 minutes to homogenize the solution. The solution was then aged under ambient conditions for at least 3 days. The mixture was deposited onto a silicon wafer by dispensing 1 ml of the mixture through a 0.2 μm Teflon filter onto the wafer. After deposition, the wafer was spun at 1000 rpm for 60 seconds to evaporate the solvent and dry the film. To aid in the drying of the film, an optional 90° C. bake was conducted for 1 minute. A mask was placed on the film to reveal a portion of the film and then exposed to the UV2 light source at a wavelength of 365 nm for 8.5 seconds at an exposure energy of 30 mW/cm². The exemplary film was rinsed with water followed by the aqueous 0.26 N TMAH developer solution. The wafer was rinsed again with water to remove any residual developer solution. The film was cured on hot plates in air at 90° C. for 90 seconds, 180° C. for 90 seconds, and 400° C. for 3 minutes. The exposed film with the proper negative image was obtained. The resultant photodefinable film had a thickness of 1.538 μm, dielectric constant of 2.09, and a refractive index of 1.2662.

In Example 15b, a composition was prepared in the following manner. A solution was prepared containing 8 g poly(methylmethacrylate-co-methacrylic acid) (PMMA-MAA) dissolved in 54 g of PGPE. Bis(4-tert-butylphenyl)iodonium triflate (PAG, 0.73 g) was added to 7.95 g of the PMMA-MAA/PGPE solution and mixed until it dissolved. To this solution was added the photosensitizer, isopropyl-9H-thioxanthen-9-one (ITX, 2.01 g) and the solution was mixed until the ITX dissolved. Deionized water (17.33 g) followed by methyltriethoxysilane (32.48 g) were added to this solution and the solution was shaken for 1-2 minutes to homogenize the system. The solution was then aged under ambient conditions for at least 3 days. The solution was then deposited onto a silicon wafer by dispensing 2 mL of the solution through a 0.2μ Teflon filter. After deposition, the wafer was spun at 1000 rpm for 60 seconds to evaporate the solvent and dry the film. To aid in the drying of the film an optional 90° C. bake was conducted for 1 minute. A mask was placed on the film and the film was exposed to UV2 light source at a wavelength of 365 nm for 8.5 seconds at an exposure energy of 30 mW/cm². The film on the silicon substrate was rinsed with water and placed in an aqueous 0.26N TMAH developer solution. The film was cured on hot plates in air at 250° C. for 6 minutes. The exposed film with the proper negative image was obtained. The resultant photodefinable film had a thickness of 1.9μ and a dielectric constant of 2.95.

### Example 16

### Composition That is Substantially Free of an Added Solvent

A composition was prepared in the following manner. A solution was prepared containing the PAG, 0.92 g (bis(4-tert-butylphenyl)iodonium) triflate, dissolved in 2.12 g of methyltrimethoxysilane (MTMOS). The solution was shaken for approximately 1 minutes at which time the mixture became clear. An additional 0.122 g of the PAG was added to the solution and shaken for 1 minute. The solution at this point is hazy. Afterwards, 0.145 g of the photosensitizer, isopropyl-9H-thioxanthen-9-one (ITX), is added to the solution and shaken for 1 minute. At this point, 0.5 g of water is added to the solution. The solution is then aged for approximately 24 hours until it becomes clear. Upon aging of the mixture for 5 days at room temperature, the mixture is deposited onto a Si wafer by dispensing 1 ml of the mixture through a 0.2 μm Teflon filter on the wafer. During the deposition step of the process the wafer is spinning at 500 rpm for 7 seconds before being accelerated to 1800 rpm for 40 seconds to evaporate the solvent and dry the film. A mask was placed on the film to reveal a portion of the film and then exposed to the UV2 light source for 8.5 seconds and at an exposure energy of 30 mW/cm². The exemplary film was rinsed with water followed by aqueous 0.26 M TMAH developer solution. The wafer was rinsed again with water to remove any residual developer solution. The film was cured on hot plates in air at 90° C. for 90 seconds, 180° C. for 90 seconds, and 400° C. for 3 minutes. The exposed film with the proper negative image was obtained. The resultant photodefinable film had a thickness of 3.9 μm and a dielectric constant of 2.43.

1. A composition for preparing a photodefinable material comprising a dielectric constant of less than about 3.5, the composition comprising:
at least one silica source capable of being sol-gel processed and having a molar ratio of carbon to silicon within the silica source of at least about 0.5;
optionally at least one solvent;
at least one photoactive compound; and water; wherein the composition comprises less than about 0.1% by weight of an added acid having a molecular weight of less than about 500.

2. The composition of claim 1 further comprising at least one porogen that is incapable of forming a micelle in the composition.

3. The composition of claim 2 wherein the porogen comprises at least one member selected from the group consisting of labile organic groups, high boiling point solvents, decomposable polymers, dendrimeric polymers, hyper-branched polymers, polyoxyalkylene compounds, small molecules, and combinations thereof.

4. The composition of claim 3 wherein the porogen comprises at least one polyoxyalkylene compound selected from the group consisting of polyoxyalkylene polymers, polyoxyalkylene copolymers, polyoxyalkylene oligomers, and combinations thereof.

5. The composition of claim 3 wherein the porogen comprises at least one decomposable polymer selected from the group consisting of polymethylmethacrylate methylacrylic acid co-polymers (PMMA-MAA) or other acrylate polymers or copolymers, poly(alkylene carbonates), polyurethanes, polyethylene, polystyrene, other unsaturated carbon-based polymers and copolymers, poly(oxyalkylene), epoxy resins, and siloxane copolymers and combinations thereof.

6. (canceled)

7. The composition of claim 1 wherein the photoactive compound comprises at least one member selected from the group consisting of a photoacid generator, a photobase generator, a photosensitizer, and combinations thereof.

8. The composition of claim 7 wherein the photoactive compound comprises at least one photoacid generator.

9. The composition of claim 8 wherein the photoactive compound further comprises at least one photosensitizer.

10. (canceled)

11. (canceled)

12. The composition of claim 1 wherein solvent comprises at least one member selected from alcohols, ketones, amides, alcohol ethers, glycols, glycol ethers, nitrites, furans, ethers, glycol esters, esters, and combinations thereof.

13. The composition of claim 1 wherein the silica source comprises at least one compound selected from a group consisting of compounds represented by the following formulas:
a. RₐSi(OR¹)₄₋ₐ, wherein R independently represents a hydrogen atom, a fluorine atom, or a monovalent organic group; R¹ represents a monovalent organic group; and a is an integer of 1 or 2;
b. Si(OR²)₄, where R² represents a monovalent organic group;
c. R³_{b}(R⁴O)_{3-b}Si—R⁷—Si(OR⁵)_{3-c}R⁶_{c}, wherein R⁴ and R⁵ may be the same or different and each represents a monovalent organic group; R³ and R⁶ may be the same or different; b and c may be the same or different and each is a number of 0 to 3; R⁷ represents an oxygen atom, a phenylene group, a biphenyl, a naphthalene group, or a group represented by —(CH₂)ₙ—, wherein n is an integer of 1 to 6; and mixtures thereof.

14. A process for preparing a patterned film comprising a dielectric constant of less than about 3.5 on at least a portion of a substrate, the process comprising:
providing a composition comprising: at least one silica source capable of being sol-gel processed and having a molar ratio of carbon to silicon within the silica source of at least about 0.5; optionally at least one solvent; at least one photoactive compound; and water provided the composition contains less than about 0.1% by weight of an added acid where the acid has a molecular weight of less than about 500.
depositing the composition onto at least a portion of the substrate to form a coated substrate;
exposing the coated substrate to an ionizing radiation source;
applying a developer solution to the coated substrate to form a patterned coated substrate;
rinsing the coated substrate to remove residual developer solution; and
curing the patterned coated substrate to provide the patterned film.

15. The process of claim 14 further comprising baking the coated substrate prior to exposing to an ionizing radiation source.

16. The process of claim 14 further comprising baking the coated substrate after exposing.

17. The process of claim 14 further comprising treating the patterned coated substrate with an energy source selected from electron beam, photon, ultraviolet light, X-ray, thermal, and combinations thereof after curing.

18. The process of claim 14 wherein the developer solution comprises at least one member selected from an aqueous solution, a non-aqueous solution, water, and combinations thereof.

19. (canceled)

20. The process of claim 14 wherein the ionizing radiation source comprises ultraviolet and visible light.

21. The process of claim 20 wherein ultraviolet and visible light is 500 nanometers or less.

22. A patterned film prepared from the process of claim 14.

23. (canceled)

24. The film of claim 22 further comprising pores and wherein the pores comprise at least one selected from mesoporous, microporous, and combinations thereof.

25. The film of claim 22 wherein the film does not exhibit diffraction peaks at a d-spacing greater than 10 Angstroms.

26. The film of claim 22 wherein the film is self-planarizing or planarizes substrates or features on a substrate.

27. An electronic device comprising the film of claim 22.

28. The electronic device of claim 27 wherein the device comprises at least one member selected from the group consisting of thin film transistor array comprising gate electrodes, gate dielectric, semiconductor, source and drain electrodes.

29. The electronic device of claim 27 wherein the device comprises a display backplane.

30. The electronic device of claim 27 wherein the device comprises a display.
